(19) United States
(12) Patent Application Publication
(10) Pub. No.: US 2025/0370807 A1
(43) Pub. Date: Dec. 4, 2025

(54) MICROSERVICE DEVELOPMENT SUPPORT SYSTEM AND MICROSERVICE DEVELOPMENT SUPPORT METHOD

(71) Applicant: Hitachi, Ltd., Tokyo (JP)

(72) Inventors: Yoichi KAWACHIYA, Tokyo (JP); Tsuneyuki IMAKI, Tokyo (JP); Yohsuke ISHII, Tokyo (JP)

(21) Appl. No.: 19/180,528

(22) Filed: Apr. 16, 2025

(30) Foreign Application Priority Data
May 31, 2024 (JP) 2024-089376

(51) Int. Cl. G06F 9/50

(52) U.S. Cl. CPC G06F 9/5027

(57) ABSTRACT

An object of the present invention is to reduce load of microservice development. A microservice development support system includes an input unit that receives an industry type for providing a microservice, a graph selection unit that selects a trade-off relationship graph based on the received industry type, a combination processing unit that obtains a feasibility of a microservice by a combination of levels of required performance items included in the selected trade-off relationship graph, and an output unit that outputs a data store and a library function corresponding to the combination of the levels of the required performance items as a microservice configuration plan when the obtained feasibility satisfies a predetermined criterion.

### CROSS REFERENCE TO RELATED APPLICATIONS

This application claims priority to Japanese Patent Application No. 2024-089376, filed May 31, 2024, the contents of which are incorporated herein by reference in its entirety for all purposes.

### TECHNICAL FIELD

The present invention relates to a microservice development support system and a microservice development support method.

### BACKGROUND ART

A distributed transaction function is required to provide a monolithic application in which a plurality of service modules closely cooperate in one process operating in various fields, by a microservice realized by a plurality of independent service modules.

By appropriately using a library having middleware of transaction control, it is possible to efficiently provide the distributed transaction function.

In the prior art, microservices for distributed transactions have been developed by introducing a specific database, an architecture for providing a distributed transaction function for a specific data format, and a distributed transaction management server.

However, there is a problem that it takes time to develop such a distributed transaction function of a microservice.

For example, for a library having transaction control middleware, there are problems that a function cannot be constructed to satisfy required performance, trial and error of performance improvement takes time in a case where the required performance cannot be satisfied, combination optimization is difficult, and architecture construction and examination take time.

Therefore, it is desired that a combination of required performance, a data store, an architecture, and the like suitable for an industry type targeted by a developer is obtained and proposed for development of a distributed transaction of a microservice.

PTL 1 discloses a management system that receives inputs of a distributed transaction flow defining a call order of a participant system and service characteristic information indicating service characteristics of each participant system, specifies, as an application pattern, a pattern satisfying a constraint condition corresponding to the service characteristics of the participant system for each participant system based on pattern information including information indicating the constraint condition of the service characteristics of the participant system as a call destination for each pattern, generates a call program to which the pattern has been applied for each participant system, and generates a distributed transaction program based on each pattern-applied call program and the call order of the participant system.

### CITATION LIST

### Patent Literature

PTL 1: JP 2022-189463 A

### SUMMARY OF INVENTION

### Technical Problem

Provided is a microservice development support system that obtains and proposes a combination of required performance, a data store, an architecture, and the like suitable for an industry type targeted by a developer of a microservice using a library of transaction control middleware in accordance with the industry type targeted by the developer, performance of a data store to be used, data to be handled, and required performance of a user using the microservice.

### Solution to Problem

he above problem is achieved by a microservice development support system including: an input unit that receives an industry type for providing a microservice; a graph selection unit that selects a trade-off relationship graph based on the received industry type; a combination processing unit that obtains a feasibility of a microservice by a combination of levels of required performance items included in the selected trade-off relationship graph; and an output unit that outputs a data store and a library function corresponding to the combination of the levels of the required performance items as a microservice configuration plan when the obtained feasibility satisfies a predetermined criterion.

### Advantageous Effects of Invention

According to the present invention, it is possible to reduce load of microservice development.

### BRIEF DESCRIPTION OF DRAWINGS

FIG. 1 is an example of a configuration diagram of a microservice development support system according to an embodiment of the present invention.

FIG. 2 is an example of data store information in the embodiment of the present invention.

FIG. 3 is an example of library information in the embodiment of the present invention.

FIG. 4 is an example of required performance information in the embodiment of the present invention.

FIG. 5 is an example of a configuration plan table in the embodiment of the present invention.

FIG. 6 is a diagram for describing a trade relationship graph in the embodiment of the present invention.

FIG. 7 is an example of a method for obtaining a combination of required performance in the embodiment of the present invention.

FIG. 8 is an example of a method for obtaining feasibility using a weight between required performances in the embodiment of the present invention.

FIG. 9 is an adjustment example of required performance using the trade relationship graph in the embodiment of the present invention.

FIG. 10 is a selection example of a data store using the trade relationship graph in the embodiment of the present invention.

FIG. 11 is a selection example of a library function using the trade relationship graph in the embodiment of the present invention.

FIG. 12 is an example of a flowchart illustrating processing of the microservice development support system in the embodiment of the present invention.

FIG. 13 is an example of a flowchart illustrating combination processing in the embodiment of the present invention.

FIG. 14 is an example of a flowchart illustrating processing of architecture selection processing in the embodiment of the present invention.

FIG. 15 is an example of a flowchart illustrating processing of library selection processing in the embodiment of the present invention.

FIG. 16 is an example of an output screen in the embodiment of the present invention.

### DESCRIPTION OF EMBODIMENTS

Hereinafter, embodiments of the present invention will be described with reference to the drawings. Note that, in the drawings for describing the embodiments, the same constituent elements are denoted by the same names and reference signs as many as possible, and repeated description thereof will be omitted.

The present invention is not limited to the embodiments which will be described later, and includes various modifications and equivalent configurations within the spirit of the appended claims. For example, the above embodiments are described in detail in order to explain the present invention in an easy-to-understand manner, and the present invention is not necessarily limited to a case including all the described configurations.

In addition, some or all of processing units and processing modules described in the embodiments may be realized by hardware by, for example, designing with an integrated circuit, or may be realized by software by a processor interpreting and executing a program for realizing each function.

The information described in the embodiments may be a table, a database (DB), or data stored in a main storage memory.

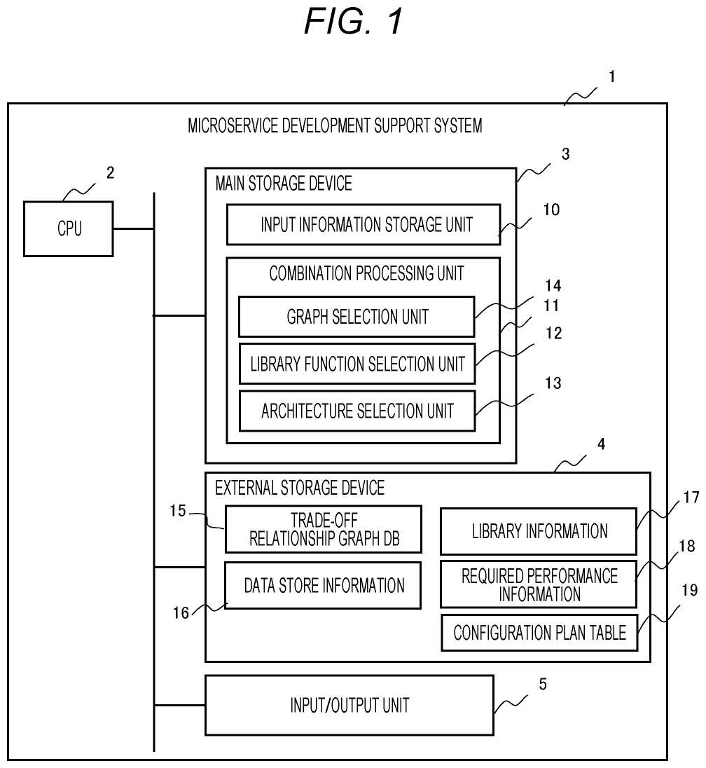

FIG. 1 is an example of a configuration diagram of a microservice development support system according to an embodiment of the present invention.

A microservice development support system 1 includes a computer including a central processing unit (CPU) 2, a main storage device 3, an external storage device 4, and an input/output unit 5. The microservice development support system 1 may be realized by using a cloud service that provides computer resources.

The main storage device 3 includes an input information storage unit 10 and a combination processing unit 11. The combination processing unit 11 includes a graph selection unit 14 that selects a trade-off relationship graph, a library function selection unit 12 that selects a function of a library, and an architecture selection unit 13 that selects a data store.

These processing units are realized as software modules and are executed by the CPU 2 with reference to data stored in the external storage device 4.

The external storage device 4 stores a trade-off relationship graph DB 15 that stores a trade-off relationship graph corresponding to an industry type, data store information 16 that stores information regarding characteristics of a data store, library information 17 that stores function information of a library, required performance information 18 that stores a required performance level of a required performance item, and a configuration plan table 19 that stores configuration information satisfying a condition input by a user. The external storage device 4 includes devices such as a hard disk drive (HDD) and a solid state drive (SSD).

The input/output unit 5 receives a processing request from the user and outputs a processing result of the microservice development support system. The input/output unit 5 may be divided into an input unit and an output unit. A network interface card (NIC) and a host bus adapter (HBA) are included.

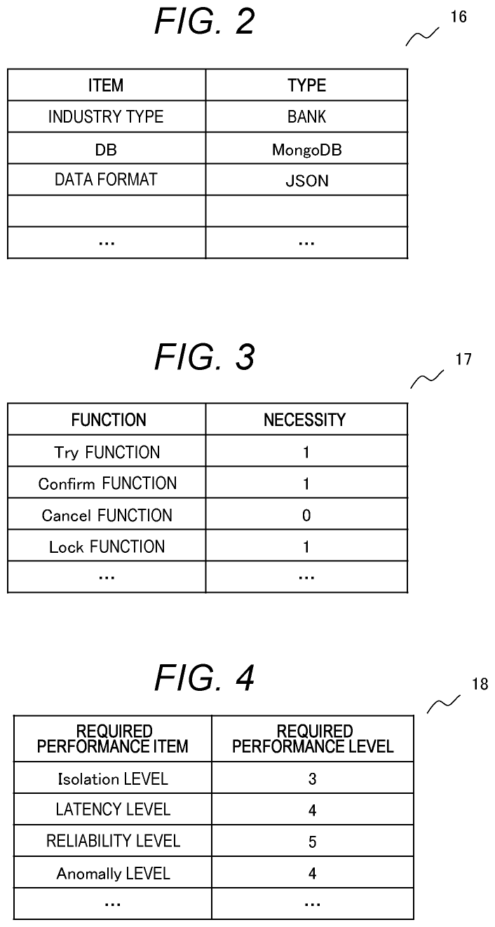

FIG. 2 is an example of data store information in the embodiment of the present invention.

The type of each item input by the user is stored. The type to be stored varies depending on a use method of the user, but at least the input of the industry type is received.

The industry type is used to select a trade-off relationship graph reflecting the microservice feasibility at a performance item level for each industry type. For other items, designation of a type is received and used to obtain a configuration that preferentially uses the received type.

FIG. 3 is an example of library information in the embodiment of the present invention.

A function of a library and a value designating necessity of the function by 1 and 0 are stored. For a library function designated as having a library function, a configuration in which the function can be used is preferentially selected.

FIG. 4 is an example of required performance information in the embodiment of the present invention.

The required performance item and the required performance level of the required performance are stored in association with each other. As the required performance item, there are an Isolation level (isolation) for controlling the behavior of a transaction, a latency level which is a time until a request is processed, a reliability level such as an ACID characteristic, and the like, and the level can be designated by a numerical value defined in the microservice development support system.

Here, the ACID characteristic is Atomicity, Consistency, Isolation, and Durability.

In providing a microservice, which required performance item is important is designated. The degree of importance of each required performance item varies depending on the industry type, and may vary depending on a target customer, system size, and the like in the same industry type.

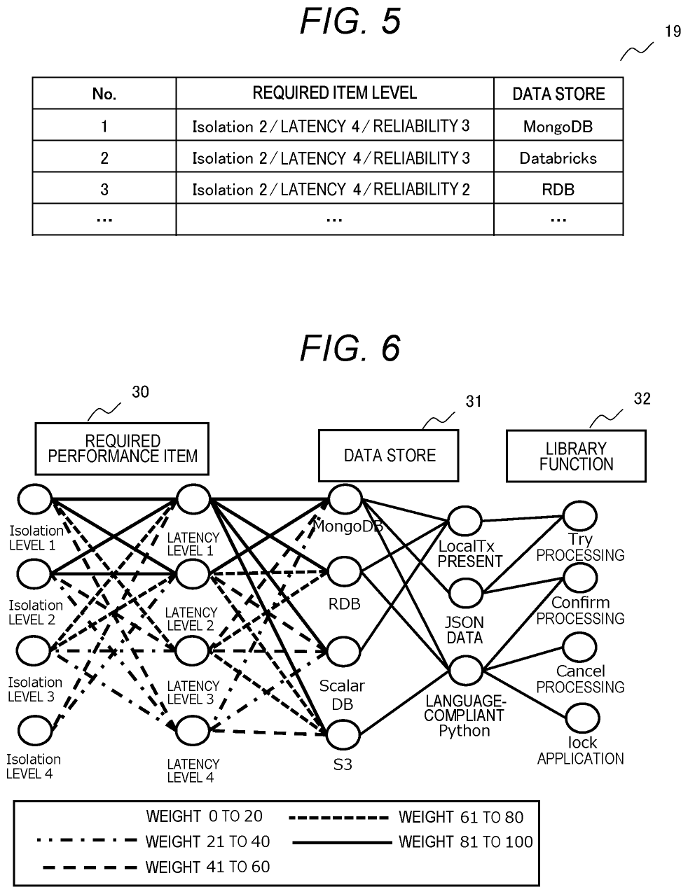

FIG. 5 is an example of a configuration plan table in the embodiment of the present invention.

A combination plan of the required item level and the data store obtained by the combination processing unit 11 is stored.

FIG. 6 is a diagram illustrating a trade relationship graph in the embodiment of the present invention. A required performance item 30, a data store 31, and a library function 32 are included. The required performance item 30 includes a required performance item node. The data store 31 includes a data store node. The library function 32 includes a library function node. Other items may be included.

In the required performance item 30, nodes indicating a level of required performance such as an isolation level are connected by edges. In a case where there is an edge, it is indicated that a combination of nodes connected by the edge can be realized. Further, a weight indicating feasibility is given to each edge.

The Isolation level 4 is more difficult to realize than the Isolation level 1. Similarly, the latency level 4 is a more difficult level to realize than the latency level 1.

In this example, a solid line edge indicates feasibility of 81% to 100%, and a broken line edge indicates feasibility of 61% to 80%, 41% to 60%, and 21% to 40% depending on the type of the broken line. No line indicates feasibility of 0% to 20%.

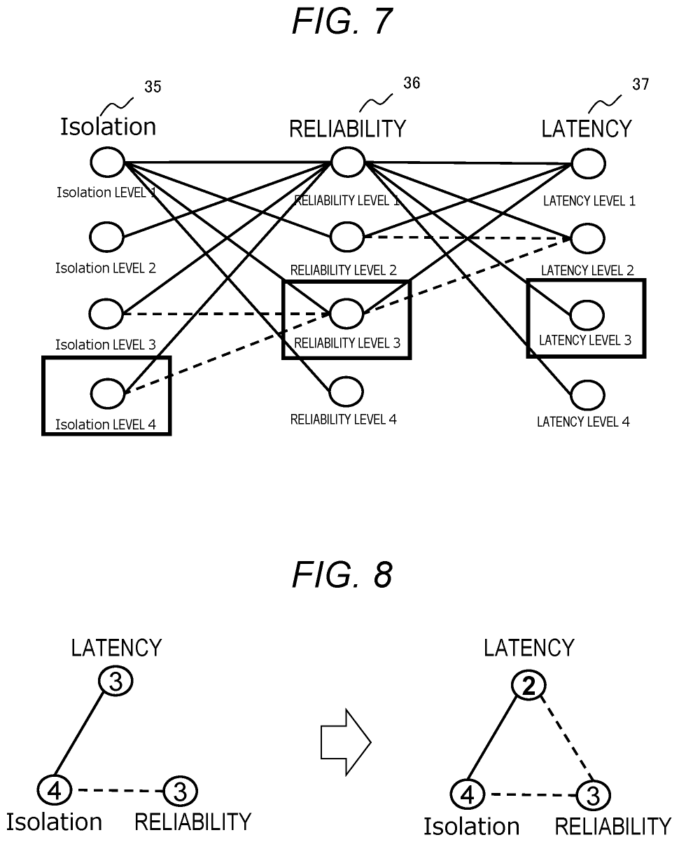

The feasibility may be defined in more detail, or may be defined in two types of 0% and 100%. Although not displayed in the trade relationship graph of FIG. 7, the feasibility may be defined between the Isolation level and the data store.

In this example, it is indicated that it is 100% possible to realize the latency level 1 at the Isolation level 1, and in this case, it is also possible to use any data store of MongoDB (registered trademark), RDB (Relational Data Base), Scalar DB, and S3.

It is indicated that, in a case using MongoDB, any of Local TX (local transaction), JSON data, and language-compliant Python (registered trademark) can be used, and in a case using JSON data, a library function that performs Try processing and Confirm processing can be used.

However, it is indicated that it is difficult to use the data store S3 when the Isolation level 4 and the latency level 4 are selected.

FIG. 7 is an example of a method for obtaining a combination of required performance in the embodiment of the present invention.

A case where the required performance of the Isolation level 4, the reliability level 3, and the latency level 3 is designated, and the trade-off relationship graph selected based on the industry type is a graph indicating the feasibility as illustrated in FIG. 8 will be described.

For easy description, it is assumed that an edge indicated by a solid line indicates feasibility of 100%, an edge indicated by a dotted line indicates feasibility of 40%, and a case where an edge is not described indicates feasibility of 0%.

Furthermore, in this example, it is assumed that there is feasibility of 100% between Isolation and latency regardless of the level.

As can be seen from FIG. 7, it is understood that at the designated level of required performance, no edge is described between the reliability level 3 and the latency level 3, and the feasibility is 0%.

When this relationship is illustrated in the left diagram of FIG. 8, a triangle having no edge between latency and reliability is obtained. The average value of the weights of the edges in this case is (100%+40%+0%)/3≈47%. Therefore, the average value of the weights of the edges is obtained by lowering any level of the required performance having the smallest edge weight.

Since the weight of the edge does not increase even though the reliability level is lowered, when the weight of the latency level is lowered, the weight of the edge between the latency and the reliability is 40% as illustrated in the right diagram of FIG. 8, and the average value of the weights of the edges is (100%+40%+40%)/3=60%.

In a case where the feasibility is set to 50% or more, it is possible to obtain a combination of the required performance items that can be realized by changing such a required performance level.

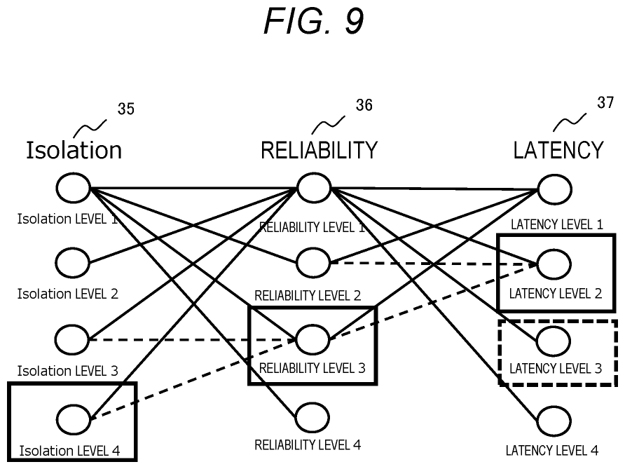

As a result, a graph for selecting the latency level 2 surrounded by a solid line from the latency level 3 surrounded by a dotted line as in the trade-off relationship graph illustrated in FIG. 9 is obtained, and the validity of the level of the required performance item can be confirmed.

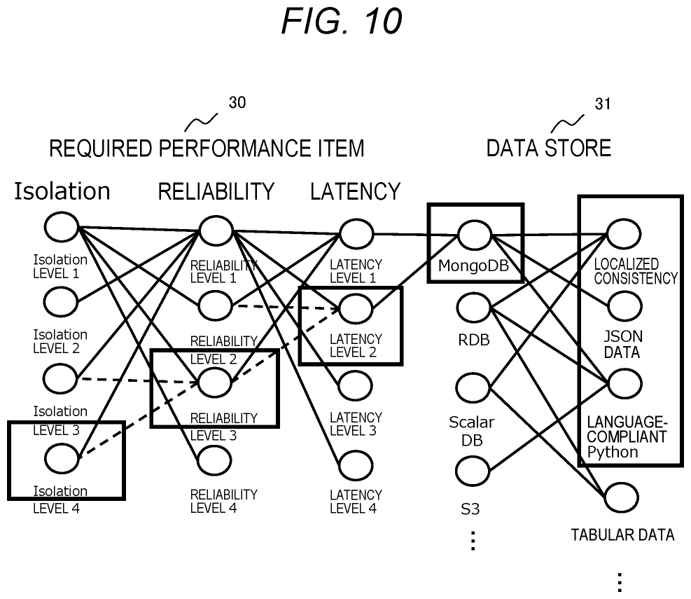

FIG. 10 is a selection example of a data store using the trade relationship graph in the embodiment of the present invention. In this graph, items other than the required performance item and the data store are omitted. As illustrated in FIG. 10, in a case where the Isolation level 4, the reliability level 3, and the latency level 2 are selected, the feasible data store is MongoDB.

Then, characteristics of MongoDB are local consistency, use of JSON data, and language-compliant Python.

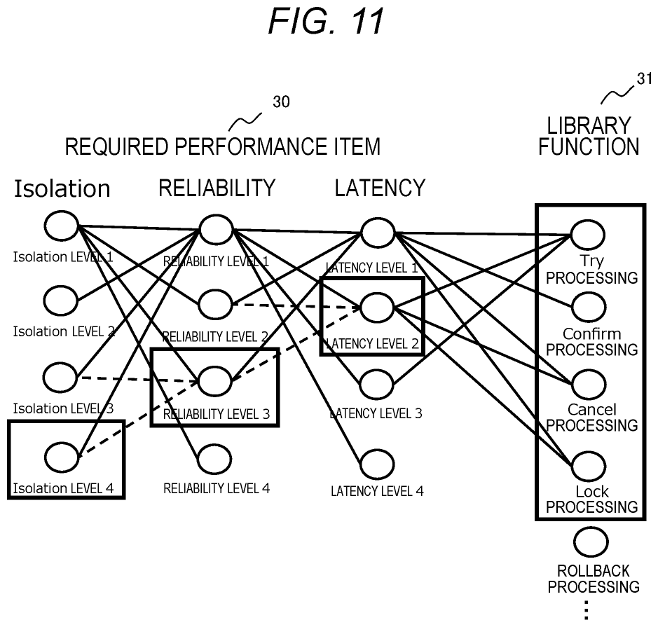

FIG. 11 is a selection example of the library function using the trade relationship graph in the embodiment of the present invention. In this graph, items other than the required performance item and the library function are omitted. As illustrated in FIG. 11, in a case where the Isolation level 4, the reliability level 3, and the latency level 2 are selected, it is indicated that the available library functions are Try processing, Confirm processing, Cancel processing, and Lock processing.

Next, processing in a case where the above processing is executed by the microservice development support system 1 illustrated in the block diagram of FIG. 1 will be described.

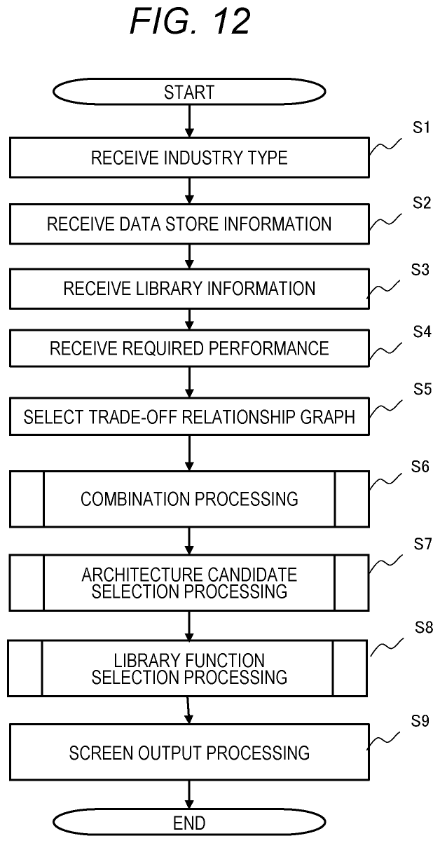

FIG. 12 is an example of a flowchart illustrating processing of the microservice development support system in the embodiment of the present invention.

The input information storage unit 10 receives the selection of the industry type and stores the selection in the data store information 16 (S1). Then, data store information such as the type of DB to be used and the type of data format to be used other than the industry type is received (S2) and stored in the data store information 16.

Library information that is a function that is likely to be used by the user of the microservice is received (S3) and stored in the library information 17.

Required performance such as the Isolation level indicating the degree that a plurality of types of transaction processing do not interfere with each other, the latency level which is a response time of the database, and the reliability level of the transaction processing is received (S4) and stored in the required performance information 18.

Each level may be defined in the microservice development support system. In the present embodiment, each level is defined in five levels from level 1 to level 5, and level 5 is the highest level.

If candidates for the industry type and the DB supported by the microservice development support system are displayed and made selectable, a more reliable configuration can be proposed.

Since the industry type is essential information, an error may be output in a case where the industry type is not selected, but other information does not need to be selected.

Then, a trade-off relationship graph to be used based on the received industry type is obtained from the trade-off relationship graph DB 15 (S5).

The trade-off relationship graph is a graph as illustrated in FIG. 6. A required performance item 30, a data store 31, and a library function 32 are included. Other items may be included.

The combination processing unit 11 changes the Isolation level, the latency level, the reliability level, and the like by using the obtained trade-off relationship graph, thereby obtaining each combination of the required performance level having a high feasibility (S6).

The architecture selection unit 13 obtains a data store corresponding to the obtained combination of the required performance level (S7).

The library function selection unit 12 obtains a library function supported by the obtained data store (S8).

The input/output unit 5 outputs the selected level of required performance, data store, library function, and the like to a screen (S9).

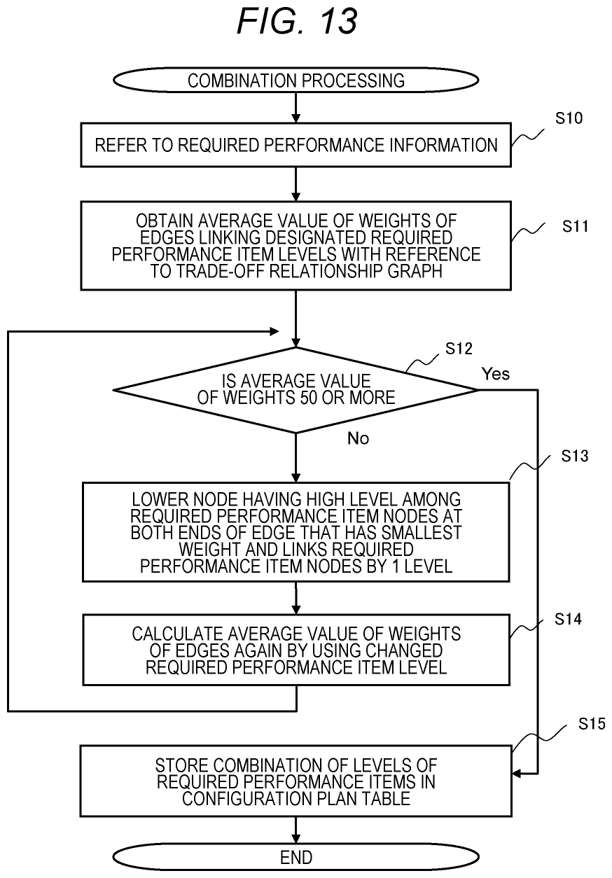

FIG. 13 is an example of a flowchart illustrating combination processing in the embodiment of the present invention.

The required performance item level designated by the user is obtained with reference to the required performance information 18 (S10). In a case where the required performance item level is not designated by the user, the highest required performance item level is set as a default.

The trade-off relationship graph selected based on the industry type is acquired from the trade-off relationship graph DB 15, and the average value of the weights of the edges indicating the feasibility of linking the designated required item levels is obtained (S11).

It is determined whether or not the obtained average value of the weights is a predetermined value or more (S12).

In this example, the determination is made based on whether or not the value exceeds 50, but a higher value or a lower value may be used. In a case using the lower value, microservice development becomes more difficult, and in a case using the higher value, microservice development becomes easier.

In a case where the value does not reach the predetermined value, a node having a high level among the required performance item nodes at both ends of the edge that has the smallest weight and links the required performance item nodes is lowered by 1 level (S13). The average value of the weights of the edges may be adjusted to 50 or more based on other criteria.

The average value of the weights of the edges is calculated again by using the changed required performance item level (S14), and the process returns to S12 to determine the average value of the weights.

When the average value of the weights is the predetermined value or more in S12, the combination of the levels of the required performance items satisfying the condition is stored in the configuration plan table 19 (S15).

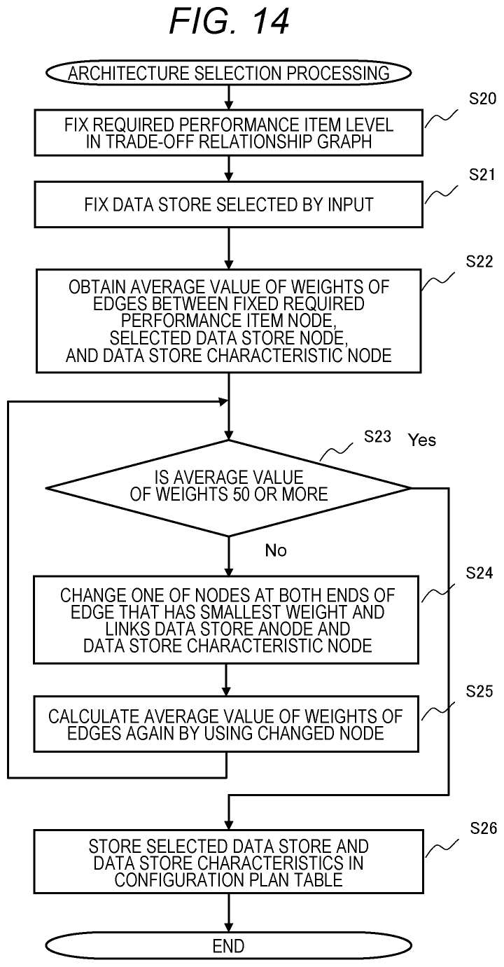

FIG. 14 is an example of a flowchart illustrating processing of architecture selection processing in the embodiment of the present invention.

The required performance item level obtained by the combination processing is fixed in the trade-off relationship graph (S20). In a case where the user specifies a data store, the data store node is fixed (S21).

The average value of the weights of the edges between the fixed required performance item node, the selected data store node, and the data store characteristic node is obtained (S22). In a case where no data store is designated, a default data store is used.

It is determined whether or not the obtained average value is a predetermined value or more (S23). In this example, the determination is made based on whether or not the value is 50 or more.

In a case where the value does not reach the predetermined value, one of the nodes at both ends of the edge that has the smallest weight and links the data store node and the data store characteristic node is changed (S24).

In a case where the data store is designated, the data store node is not changed.

The average value of the weights of the edges is calculated again by using the changed nodes (S25). The process returns to S23.

In a case where the value has reached the predetermined value in S23, the selected data store and data store characteristics are stored in the configuration plan table 19 (S26).

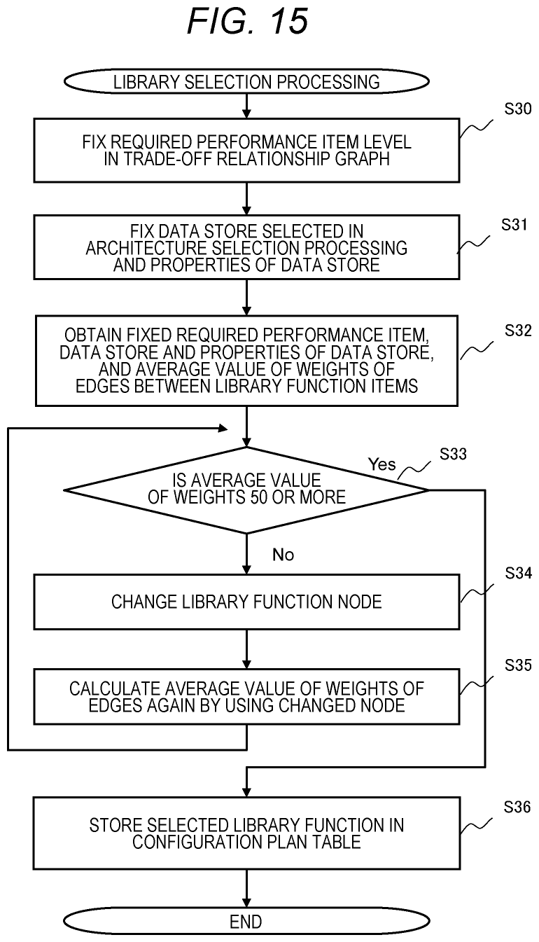

FIG. 15 is an example of a flowchart illustrating processing of library selection processing in the embodiment of the present invention.

The required performance item level obtained by the combination processing is fixed in the trade-off relationship graph (S30). The data store selected in the architecture selection processing and the properties of the data store are fixed (S31). In a case where the user designates the library function, the library function node is fixed.

The fixed required performance item, the data store and the properties of the data store, and the average value of the weights of the edges between the library function items are obtained (S32).

It is determined whether or not the obtained average value is a predetermined value or more (S33). In this example, the determination is made based on whether or not the value is 50 or more.

In a case where the value does not reach the predetermined value, the library function node is changed (S24). In a case where the library function is designated, there is no room for changing the library function, and thus an error is output.

The average value of the weights of the edges is calculated again by using the changed nodes (S35). The process returns to S33.

In a case where the value has reached the predetermined value in S33, the selected library function is stored in the configuration plan table 19 (S36).

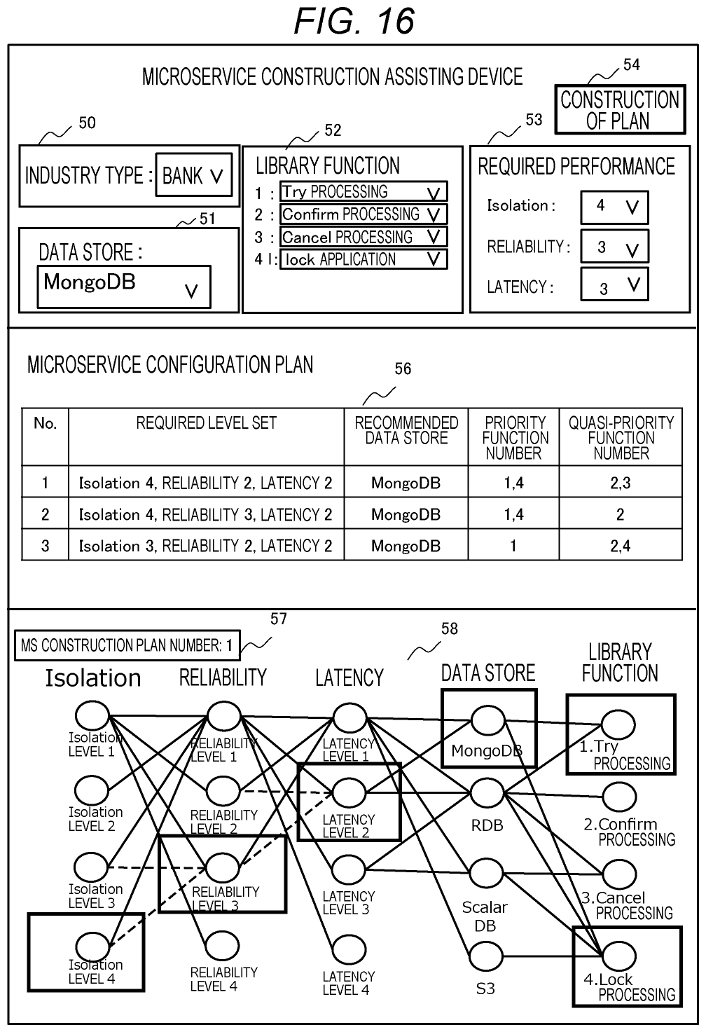

FIG. 16 is an example of an output screen in the embodiment of the present invention.

When an industry type 50, a data store 51, a library function 52, and required performance 53 are designated and a plan construction button 54 is pressed, a microservice construction plan 56 is output. When a MS construction plan number 57 is selected, a trade-off relationship graph used when the selected construction plan is obtained is displayed, and the selected node is surrounded by a square.

The industry type 50 is an essential input item for selecting the trade-off relationship graph in accordance with the industry type, but the data store 51, the library function 52, and the required performance 53 do not need to be designated. When a configuration plan exceeding predetermined feasibility is not found in the case of being input, an error occurs. In such a case, the possibility of obtaining the configuration plan is increased by making designation less.

### REFERENCE SIGNS LIST

1 microservice development support system
2 CPU
3 main storage device
4 external storage device
5 input/output unit
10 input information storage unit
11 combination processing unit
12 function selection unit of library
13 architecture selection unit
14 graph selection unit
15 trade-off relationship graph DB
16 data store information
17 library information
18 required performance information
19 configuration plan table
20 library candidate information

1. A microservice development support system comprising:
an input unit that receives an industry type for providing a microservice;
a graph selection unit that selects a trade-off relationship graph based on the received industry type;
a combination processing unit that obtains a feasibility of a microservice by a combination of levels of required performance items included in the selected trade-off relationship graph; and
an output unit that outputs a data store and a library function corresponding to the combination of the levels of the required performance items as a microservice configuration plan when the obtained feasibility satisfies a predetermined criterion.

2. The microservice development support system according to claim 1, wherein the required performance items include isolation, latency, and reliability.

3. The microservice development support system according to claim 1, wherein the trade-off relationship graph includes a required performance item node, a data store node, and a library function node, and the nodes are connected by an edge corresponding to feasibility.

4. The microservice development support system according to claim 3, wherein the edge of the trade-off relationship graph is associated with a weight indicating feasibility.

5. The microservice development support system according to claim 4, wherein the combination processing unit obtains an average value of weights associated with edges included in a combination of required performance items as feasibility of the microservice by the combination of the levels of the required performance items, and in a case where the obtained average value exceeds a predetermined value, the combination processing unit performs setting as the microservice configuration plan.

6. The microservice development support system according to claim 5, wherein, in a case where the obtained average value does not reach the predetermined value, the combination processing unit lowers a level of the required performance item connected by an edge that links the required performance item nodes and has the smallest weight, and obtains the average value again.

7. The microservice development support system according to claim 1, wherein the input unit receives the level of the required performance item,
the combination processing unit obtains the feasibility of the microservice based on the level of the required performance item received by the input unit, and
the output unit outputs the data store and the library function corresponding to the combination of the levels of the required performance items as the microservice configuration plan that satisfies the received level of the required performance item.

8. The microservice development support system according to claim 1, wherein the input unit receives a data store,
the combination processing unit obtains a microservice configuration plan having the highest required performance level in a case using the received data store, and
the output unit outputs the obtained microservice configuration plan having the highest required performance level.

9. A microservice development support method comprising:
receiving an industry type for providing a microservice by an input unit;
selecting a trade-off relationship graph based on the received industry type by a graph selection unit;
obtaining a feasibility of a microservice by a combination of levels of required performance items included in the selected trade-off relationship graph, by a combination processing unit; and
outputting a data store and a library function corresponding to the combination of the levels of the required performance items as a microservice configuration plan by an output unit when the obtained feasibility satisfies a predetermined criterion.
